(19) United States
(12) Patent Application Publication
(10) Pub. No.: US 2017/0153631 A1
(43) Pub. Date: Jun. 1, 2017

(54) METHOD, NODES AND COMPUTER PROGRAM OF A TOOL COMMUNICATIONS NETWORK

(71) Applicant: ATLAS COPCO INDUSTRIAL TECHNIQUE AB, Stockholm (SE)

(72) Inventor: Bo JONSSON, ÄLTA (SE)

(73) Assignee: ATLAS COPCO INDUSTRIAL TECHNIQUE AB, Stockholm (SE)

(21) Appl. No.: 15/323,558

(22) PCT Filed: Jun. 30, 2015
(86) PCT No.: PCT/EP2015/064814

§ 371 Date: Jan. 3, 2017

(30) Foreign Application Priority Data
Jul. 3, 2014 (SE) 1450839-4

(51) Int. Cl. G05B 19/418; H04L 12/58; H04L 29/08

(52) U.S. Cl. CPC G05B 19/4185; H04L 67/125; H04L 51/10; H04L 67/146; G05B 2219/31105

(57) ABSTRACT

A method performed by a tool communications network for remote control of power tools includes: determining control data and arranging the control data in a message structure by a tool server. The message structure includes a message header for message transmission and a message body, including at least one data container, for carrying control data. The data container contains at least one individual control data item containing metadata and value data, and is expressed in a binary format. The method also includes: transmitting by the tool server a message based on the message structure including the control data; receiving by a tool controller the message based on the message structure comprising the control data; and storing the control data according to the message structure in a database of a plurality of tool controllers. At least one power tool is connected to at least one tool controller.

### TECHNICAL FIELD

The present invention relates generally to a method, arrangement, transmitter node, receiver node control system and computer program of a tool communications network for enabling of remote control of power tools.

### BACKGROUND ART

Power tools and systems with power tools, including portable power tools such as power wrenches operated by an operator, are often used in production work. A common application is in assembly lines. Nowadays, power tools in assembly lines may have a controller connected to them and the controller controls the work performed by the tool so that the tool works automatically. I.e. the controller sees to that the tool is operated correctly, e.g. performing a wrench operation with the correct torque etc.

Sometimes it is necessary to update the controller with new information. For example, the tools may have to perform new operations, change dimensions or torque or just adjust the current operation for a better performance.

In prior art, when an update of data is needed to tool controllers in an environment where there are many tool controllers, an operator has needed to connect to one controller at a time, to re-program the controllers. This is very time consuming. Also, it has sometimes been necessary to visit each different controller physically, which is even more time consuming. Consequently, there is a need to facilitate updating of data in an environment comprising many tool controllers.

Further, data of how the controlling of the tools functions, i.e. data of the result of the work performed by the tools may be collected by the tool controllers. Consequently, there is a need to facilitate collecting data relating to the work performed by the tools connected to the tool controllers.

Further, it has not been possible to pre-plan for example a new production line of a factory comprising a number of tool controllers and to implement such a pre-planning in a fast and easy way.

Further, the controllers may be remotely located and may be equipped with processors for tool control and not for intensive data processing.

As shown above, there is a need to be able to facilitate communication in an environment comprising many tool controllers.

### SUMMARY

It is an object of the invention to address at least some of the problems and issues outlined above. It is possible to achieve these objects and others by using a methods, nodes network and computer program as defined in the attached independent claims.

According to one aspect, a method is provided performed by a tool communications network for enabling of remote control of power tools. The tool communications network comprises a tool server, a communication node and a tool controller. At least one power tool is connected to the tool controller. The method comprises determining control data, by the tool server. The method comprises arranging the control data in a message structure, by the tool server. The message structure comprises a message header for message transmission and a message body for carrying control data. The message body comprises at least one data container, wherein the data container contains at least one individual control data item, wherein the message is arranged such that when a message body contains a plurality of data containers, an individual data container or individual control data item is possible to interpret of the message structure, the control data item contains both metadata and value data, and the control data item is expressed in a binary format. The method comprises transmitting a message based on the message structure comprising the control data, by the tool server. The method comprises receiving the message based on the message structure comprising the control data, by the tool controller. The method comprises storing the control data according to the message structure in a database, of the tool controller.

According to another aspect, a message arrangement for use in a tool communications network for enabling of remote control of power tools is provided. The tool communications network comprising a tool server and a tool controller, wherein at least one power tool is connected to the tool controller. The message arrangement comprises a message structure which comprises a message header for message transmission and a message body for carrying control data. The message body comprises at least one data container. The data container contains at least one individual control data item, wherein the message is arranged such that when a message body contains a plurality of data containers, an individual data container or individual control data item is possible to interpret of the message structure. The control data item contains both metadata and value data. The control data item is expressed in a binary format.

According to another aspect, a method is provided performed by a transmitter node in a tool communications network for enabling of remote control of power tools. The tool communications network comprises a tool server and a tool controller. At least one power tool is connected to the tool controller. The method comprises arranging control data in a message structure. The method comprises transmitting a message based on the message structure to a receiver node.

According to another aspect, a method is provided performed by a receiver node in a tool communications network for enabling of remote control of power tools. The tool communications network comprising a tool server and a tool controller. At least one power tool is connected to the tool controller. The method comprises receiving a message based on a message structure from a transmitter node. The method comprises interpreting control data in a message structure.

According to another aspect, a tool communications network is provided for enabling of remote control of power tools. The tool communications network comprises a tool server, a communication node and a tool controller. At least one power tool is connected to the tool controller. The tool communications network comprises a determination unit for determination of control data, comprised by the tool server. The tool communications network comprises an arrangement unit for arrangement of the control data in a message structure, comprised by the tool server. The message structure comprises a message header for message transmission and a message body for carrying control data, the message body comprising at least one data container. The data container contains at least one individual control data item, wherein the message is arranged such that when a message body contains a plurality of data containers, an individual data container or individual control data item is possible to interpret of the message structure, the control data item contains both metadata and value data, and the control data item is expressed in a binary format. The tool communications network comprises a transmission unit for transmission of a message based on the message structure comprising the control data, comprised by the tool server. The tool communications network comprises a reception unit for reception of the message based on the message structure comprising the control data, comprised by the tool controller. The tool communications network comprises a control unit for storage of the control data according to the message structure in a database, comprised by the tool controller.

According to another aspect, a transmitter node is provided in a tool communications network for enabling of remote control of power tools. The tool communications network comprises a tool server and a tool controller. At least one power tool is connected to the tool controller. The transmitter node comprises an arrangement unit for arrangement of control data in a message structure. The transmitter node comprises a transmission unit for transmission of a message based on the message structure to a receiver node.

According to another aspect, a receiver node in a tool communications network is provided for enabling of remote control of power tools. The tool communications network comprises a tool server and a tool controller. At least one power tool is connected to the tool controller. The receiver node comprises a reception unit for reception of a message based on a message structure from a transmitter node. The receiver node comprises a control unit for interpretation of control data in the message structure.

According to another aspect, a computer program and a computer program product comprises computer readable code is provided, which when run on a transmitter node, causes the transmitter node to behave as a transmitter node described in previous sections.

According to another aspect, a computer program and a computer program product comprising computer readable code is provided, which when run on a receiver node, causes the receiver node to behave as a receiver node described in previous sections.

The above method, arrangement, nodes and computer program may be configured and implemented according to different optional embodiments. In one possible embodiment, the message structure may be used by a compiler for generation of a computer program for a transmitter node, and a computer program for a receiver node. In one possible embodiment, the message body may comprise a plurality of data containers, wherein a data container contains at least one sub data container. In one possible embodiment, the metadata may determine at least one of: value type, parameter, type, name length, value length, attributes length, sub data container length, name, attributes. In one possible embodiment, the value data may determine a magnitude of a power tool operation. In one possible embodiment, the message may be arranged such that when a message body contains a plurality of data containers, an individual data container or individual control data item is possible to interpret the message structure.

In one possible embodiment, the message header may comprise a section for session identification. In one possible embodiment, the message header may comprise a section for sequence identification. In one possible embodiment, when the message header may contain an operation instruction for the tool controller, the message structure only contains a message header. In one possible embodiment, a computer program may be received from a compiler for interpretation of the message structure. In one possible embodiment, the transmitter node may be comprised by one from the group of: a tool server, a communication node or a tool controller.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is an overview illustrating the solution.

FIG. 2 is a flowchart in the solution, according to some possible embodiments.

FIG. 3 is an illustrative example of an arrangement, according to possible embodiments.

FIG. 4 is an illustrative example of an arrangement, according to further possible embodiments.

FIG. 5 is a flowchart of an example of a procedure of a transmitter node, when the solution is used, according to possible embodiments.

FIG. 6 is a flowchart of an example of a procedure of a receiver node, when the solution is used, according to possible embodiments.

FIG. 7 is a block diagram illustrating the solution in more detail, according to further possible embodiments.

FIG. 8 is a block diagram illustrating a tool server in more detail, according to further possible embodiments.

FIG. 9 is a block diagram illustrating a tool controller in more detail, according to further possible embodiments.

FIG. 10 is a block diagram illustrating transmitter node in more detail, according to further possible embodiments.

FIG. 11 is a block diagram illustrating a receiver node in more detail, according to further possible embodiments.

FIGS. 12A and 12B is a block diagram illustrating a transmitter and receiver node in more detail, according to further possible embodiments.

### DETAILED DESCRIPTION

Briefly described, a solution is provided to enable remote configuration and data collection of controllers for power tools. In an environment where a number of power tools are used, normally controlled by controllers, the power tools may be configurable for different operations. A specific power tool may further be a part of a work station with material for production, arrangements for material handling, the power tool itself, different equipment for the tool, interaction devices for power tool operation such as indicator lamps, displays, and so forth.

The power tool may be set up for simple operations, or just manually controlled by an operator person. However, the power tool may be set up for complex work operations by a configuration. Such complex work operations may include a number of similar and different operations, series of operations with one equipment, shifting to another equipment followed by another series of operations and may be shifting to a third equipment. How the power tool should perform operations and interact with an operator, may be based on control data. Each individual operation may need to be performed with high accuracy in terms of e.g. torque and rotation speed. In order to maintain desirable quality control all results may be collected by sensors, such as the number of rotations, final torque, location of operation, time, and similar result data for power tool operation.

A tool controller controlling the power tool and accessory equipment has the primary task to control the power tool. However, the tool controller may also need to manage configuration data and collect sensor data and store the sensor data as results of performed work operations. It is therefore desired that the work load on a tool controller is limited as far as possible, such that the tool controller resources may be used for controlling the power tool.

The solution described in this document provides methods, nodes and a protocol arrangement for a robust and resource effective remote control of tool controllers and power tools. The solution enables an administrator to work from a client computer, for example preparing a configuration for a certain manufacturing operation. The client computer may be connected to a tool server, where the control data is prepared, how operations should be performed may be calculated, step-by-step work procedures may be registered, suitable interactions between a controller and a power tool operator designed and so forth. When a complete set of operations and interactions are prepared, it may be seen as configuration data for a controller controlling a power tool. The tool server may than arrange the configuration data in a message structure. The message structure may be suitable for interpretation by a controller. The message structure may also be suitable for transportation of configuration data in a tool communications network, for example operational in a manufacturing facility.

The tool communications network may be operated in a small manufacturing plant in a clean environment. The tool communications network may be operated in a manufacturing environment distributed over several buildings or remote locations. The tool communications network may be operated in a manufacturing environment in a factory with a challenging environment of dirt, aggressive chemicals, electrical disturbances, sometimes challenging for communication equipment and computers. Sometimes the communication may be interrupted. Even if it is a challenging environment, configuration data and result data should be conveyed between a tool server and a controller. Production stops or production disturbances need to be avoided, because they sometimes may result in significant costs.

It is therefore desired to transfer configuration data in a robust and trustworthy manner, also in challenging communication environments, without causing any unnecessary workload.

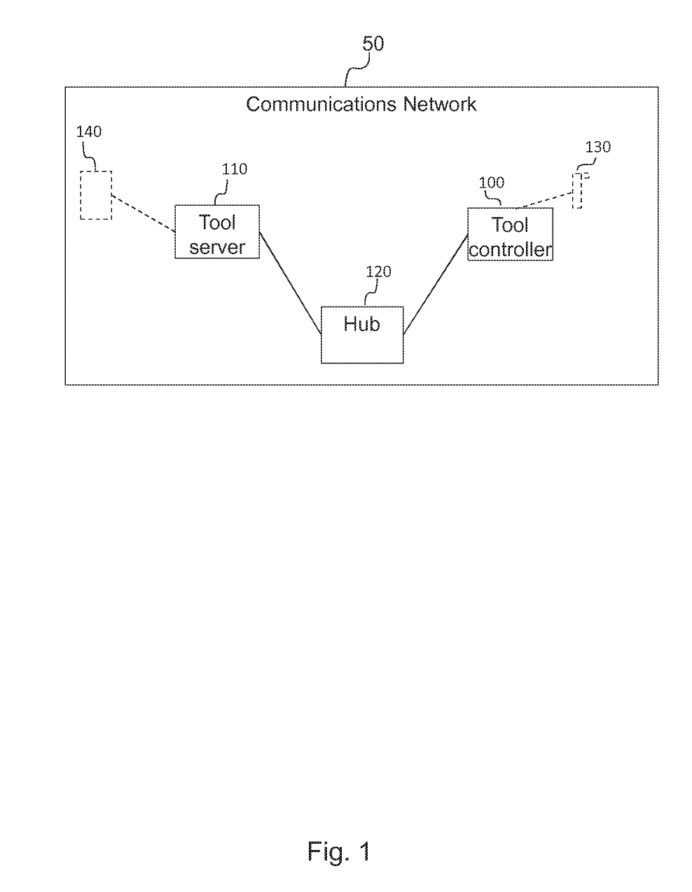

Now the solution will be described in more detail, staring with FIG. 1.

FIG. 1 shows an overview of the solution, a tool communications network 50 with a tool controller 100 for control, supervision and collection of result data from a power tool 130. The figure further shows a tool server 110 for configuration management and result data storage and a communication node 120 for management and relay of communication. A client 140 is also illustrated in the figure.

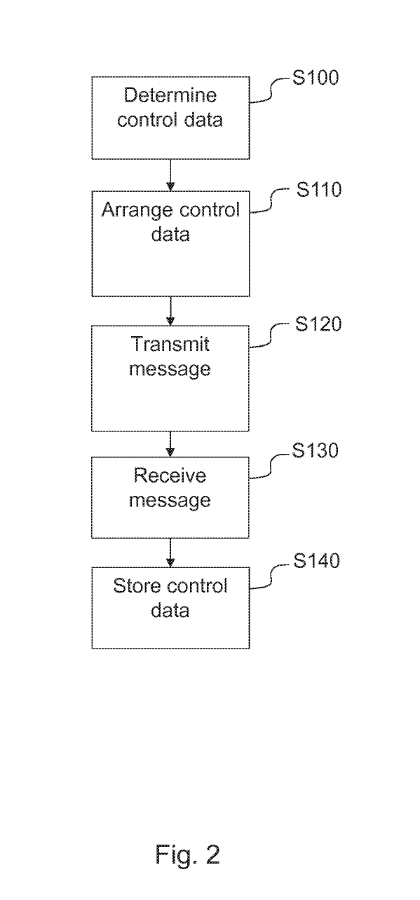

FIG. 2 shows a flow chart illustrating a method performed by a tool communications network 50 for enabling of remote control of power tools 130. The tool communications network 50 comprises a tool server 110, a communication node 120 and a tool controller 100 wherein at least one power tool 130 is connected to the tool controller 100. The method comprises determination of control data, by the tool server 110 in a step S100. The method comprises arrangement of the control data in a message structure 150, by the tool server 110 in a step S110. The message structure 150 comprises a message header for message transmission and a message body for carrying control data. The message body comprises at least one data container, wherein the data container contains at least one individual control data item. The control data item contains both metadata and value data and the control data item is expressed in a binary format. The method comprises transmission of a message based on the message structure 150 comprising the control data, by the tool server 110 in a step S120. The method comprises reception of the message based on the message structure 150 comprising the control data, by the tool controller 100 in a step S130. The method comprises storage of the control data according to the message structure 150 in a database 105, of the tool controller 100 in a step S140.

A tool communications network, such as the tool communications network 50 illustrated in FIG. 1, may be a communications network for enabling of communication between power tools and various units and devices controlling, supervising or collecting result data from the power tools. The tool communications network 50 may be based on LAN-technologies (Local Area Network) such as Ethernet (e.g. according to IEEE 802.3), TCP/UDP/IP (Transfer Control Protocol/User Datagram Protocol/Internet Protocol), wireless protocols such as Wireless LAN (e.g. according to IEEE 802.11) just to mention a few non-limiting examples. Some other non-limiting examples are PROFIBUS, PROFINET, DeviceNet, Modbus Plus, Modbus-RTU, Modbus-TCP, CC-Link, ControlNet, CANopen, CompoNet, Interbus, FIPIO, EtherCAT, Powerlink, BACNet, Sercos III, FIPIO, Lonworks, Mbus, AS-Interface, FL-net. The tool communications network may be operational in a factory or a manufacturing plant, for examples for manufacturing of consumer or industrial goods, including house hold appliances, cars, toys, machines, etc. The tool communications network may be covering or connecting a number of facilities within a closed area such a campus with a number of buildings. The tool communications network may be covering or connecting a number of factories or manufacturing plants remotely located from each other.

Remote control of a power tool 130 may include provisions of data to a power tool 130. Remote control may include provision of metadata related to data. Remote control may include provision of instructions, such as operations instructions for the power tool, or instructions for an operator of the power tool 130.

A power tool, such as the power tool 130 shown in FIG. 1 and other figures, may be a tool driven by an engine, such as an electrical, pneumatic or hydraulic engine. A power tool may be partially operated by manual power, however including means for communication and/or automatic detection of for example a torque rate, a position, tool selection, result data and similar functions.

A tool server, such as the tool server 110, may be a server which clients 140 may connect to for creation and/or administration of work operations for power tools 130. The tool server may be a general purpose server or a tool server 110 specifically arranged for remote control of power tools 130. Administrators connecting to the tool server via clients 140, may for example create, specify and change how a particular power tool 130 or a group of power tools 130 should behave in certain situations. Examples are series of operations, tool selections, values for each operation like a torque rate, number of rotations, rotational speed, position, how end when result data should be feed backed to a tool server 110, etc.

A communication node, such as the communication node 120, may be managing communication between different participating functional nodes or devices in the communications network 50. The communication node 120 may for example keep track of identities of tool controllers 100, tool servers 110, or power tools 130. The communication node 120 may keep track of any nodes or devices alternating between “on line” and “off line”. A tool controller 100 may for example not always be connected to a network for various reasons. The communication node 120 may further validate and/or authorize nodes or devices communicating in the communications network 50, such that only an authorized node has the right to communicate with another.

A tool controller, such as the tool controller 100, may be a tool controller for control of power tools. The tool controller may be a specific node for control of power tools or it may be for example a general purpose computer, which has been adapted for control of power tools. The tool controller may be connected to the tool communication network by wire or wirelessly for communication. The tool controller may receive control data and store the control data in a suitable database. The tool controller may use the control data for control of a power tool or operation of a power tool. Sensors of the tool controller or the power tool may generate result data of power tool operations. The tool controller 100 may also be termed controller, controller node, controlling node, control unit, tool processor, tool regulator, or similar terms. The tool controller 100 may be co-located or comprised by a power tool 130, a tool server 110, communication node 120, or other suitable technical nodes operating in a tool communications network 50.

A power tool, such as the power tool 130, may be controlled by the tool controller 100. Controlling a power tool 130 may for example include providing control data to the power tool 130, operating the power tool by provision of electrical power, pneumatic or hydraulic power, sensor instructions, not limiting to other types of control or regulation. Controlling the power tool 130 may for example also include detection of electrical energy consumption, sensing of pneumatic or hydraulic power, torque, torque rate, position, three dimensional position, or other types of sensor data. Example of a power tool 130 may be torque wrench, hammer, breaker, rock drill, nutrunner, screwdriver, or various combinations of those, not limiting to other similar types of power tools. A power tool 130 may be connected by wire or wirelessly.

A client 140 may be a computer, e.g. a laptop or a stationary computer that is connected wirelessly or via wire line to the tool server 110. The client may be run by an administrator and used by the administrator to for example control the function of the power tools and/or the tool controllers, by for example supervising sensor data delivered by the tool controllers to the tool server and inputting tool control data that is delivered by the tool server to the concerned tool controller for subsequent delivery to the concerned power tools of that tool controller.

In an embodiment, a message authenticity and/or authorization for relay to a tool controller (100), may be validated by the communication node 120.

When a message is handled by the communication node 120, the communication node 120 may be validating a message such that it is authentic, before it is forwarded to the tool controller 120. When a message is handled by the communication node 120, the communication node 120 may be validating a message such that it is authorized, before it is forwarded to the tool controller 120. A message from the tool controller 100 to for example a tool server 110 or another node in the tool communications network 50 may also be handled in a similar manner. In an embodiment, the communication node 120 may validate authenticate or authorize a tool controller 100 or a tool server 110. Thereby may message transmission or reception by mistake be reduced, or malicious interception may be restricted.

In an embodiment, the message structure 150 may be used by a compiler 160 for generation of a computer program for a transmitter node 170. In an embodiment, the message structure 150 may be used by a compiler 160 for generation of a computer program for a receiver node 180.

An advantage by generation of computer program based on the message structure 150 for the transmitter node 170 and the receiver node 180, may be that the both nodes may obtain similar interpretation of the message structure 150.

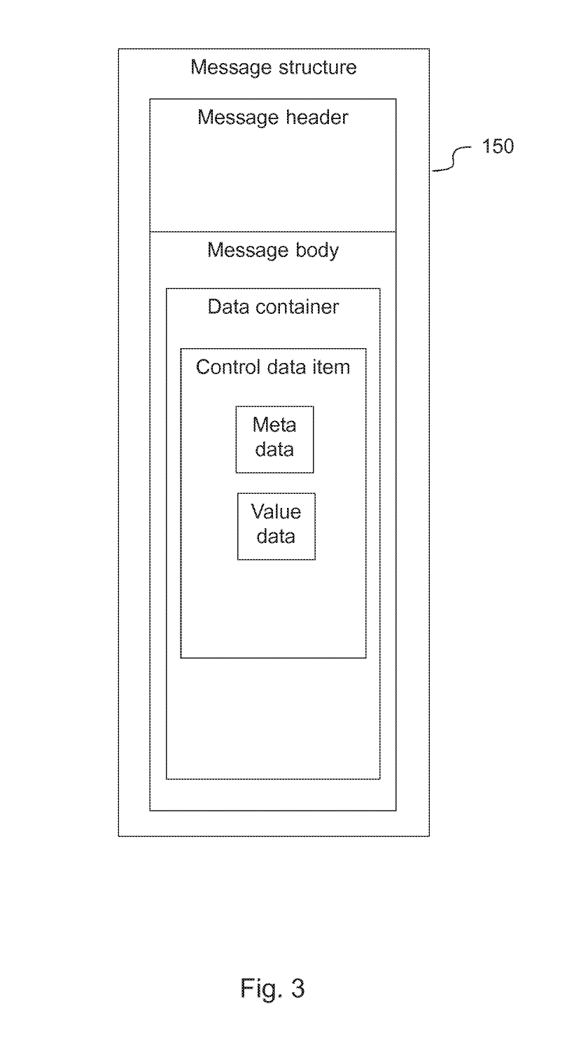

FIG. 3 illustrates a message arrangement 150 for use in a tool communications network 50 for enabling of remote control of power tools 130. The tool communications network 50 comprises a tool server 110 and a tool controller 100. At least one power tool 130 is connected to the tool controller 100. The message arrangement comprises a message structure 150 and the message structure 150 comprises a message header for message transmission and a message body for carrying control data. The message arrangement comprises that the message body comprises at least one data container, wherein the data container contains at least one individual control data item. The message arrangement comprises that the control data item contains both metadata and value data. The message arrangement comprises that the control data item is expressed in a binary format.

An advantage with control data expressed in binary format, may be that the tool controller 100 may interpret control data fast and lightweight in comparison with control data expressed in non-binary format. Thereby CPU (Central Processing Unit) resources may be saved.

In an embodiment of the message arrangement 150, the message body may comprise a plurality of data containers. A data container may contain at least one sub data container. A message body may contain a plurality of data containers, thereby it may be possible in the same message to transfer a plurality of configuration parameters and the related values.

According to an embodiment, the message arrangement comprises that the control data item may be expressed in a plain format, for example the control data item may be expressed in ascii-format, raw text or expressed in any other format interpretable by a high level programming language. According to an embodiment, the message arrangement comprises that the control data item may be expressed in a combination of binary format and plain format.

The term data container may also be termed data node, data section, pay load, not limiting other terms suitable for describing information or data carried by a message structure.

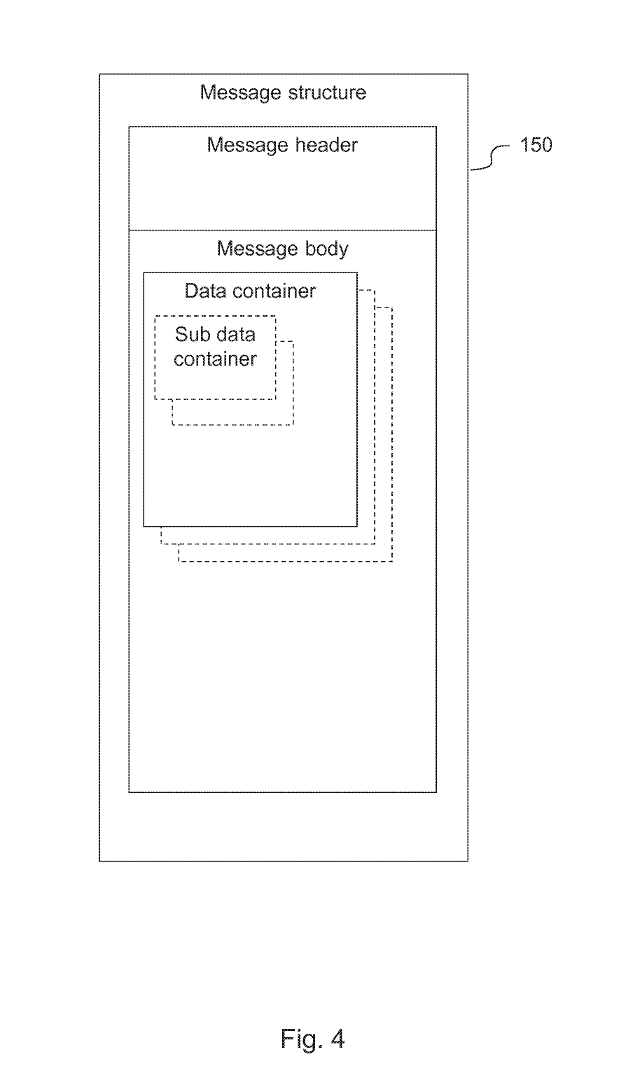

FIG. 4 shows an illustrative example, with a plurality of data containers and also a couple of sub data container. Each data container may include one or more sub data containers. Thereby it may be possible to provide in one message, a set of parameters and related values. A non-limiting example may be when one power tool 130 operation includes a number of parameters or instructions, e.g. number of rotations, torque, final torque, and position. It may thereby be possible for a receiver, such as a tool controller 100, to effectively prepare a power tool 130 operation.

In an embodiment of the message arrangement 150, the metadata may determine at least one of: value type, parameter, type, name length, value length, attributes length, sub data container length, name, attributes. The metadata may describe or specify what a value data should be for and how it should be used. A non-limiting example, a metadata may describe that the value is a torque value, maximum torque at attachment, the value is 32 bits long and so forth. When it is a sub data container, the sub data container is described by the metadata such that the sub data container may be identified and possible to interpret. When it is a result of an operation, the metadata may describe value type, parameter, etc. and may further indicate a sensed value, a time stamp, position and so forth.

In an embodiment of the message arrangement 150, value data may determine a magnitude of a power tool 130 operation. Value data may determine the result of a power tool 130 operation. Metadata may determine which kind of data the value data is, e.g. floating-point number, angle or encoding. When the metadata describes what to perform, or what has been performed, the value data may describe how it should be performed. A few non-limiting examples: a fastener or a nut should be fastened with a certain torque, the value data specifies the torque. In a series of operations, the value data may specify where in the series of operations a certain operation should be performed. Value data may be a result data of a certain operation or activity.

In an embodiment of the message arrangement 150, the message may be arranged such that when a message body contains a plurality of data containers, an individual data container may be possible to interpret of the message structure 150. In an embodiment of the message arrangement 150, the message may be arranged such that when a message body contains a plurality of control data items, an individual control data item may be possible to interpret of the message structure.

It may for a receiver of the message be possible to interpret the structure of data containers and sub data containers, such that an individual data container or an individual control data item may be possible to interpret, without parsing and interpreting the entire message. When an update should be made of a certain control data, only a particular data container or control data item may be necessary to parse out of the entire message structure 150.

An advantage is thereby effective usage of CPU resources.

An advantage is thereby for a receiver to only update changed or relevant control data for that receiver.

In an embodiment of the message arrangement 150, the message header may comprise a section for session identification. A tool communications network 50 may be operated in a challenging network environment with disturbances, wireless connected devices operated on battery and some areas might be out of network reach. Therefore it may be desired to be able to handle situations where the communication between two nodes is either temporarily broken, or when the communication is disturbed such that different ongoing conversations between two communication nodes can be kept intact. A non-limiting example is, if the communication between a tool server 110 and a tool controller 100 is interrupted in the middle of provision of a new configuration, whenever the communication is reestablished, the reconfiguration should continue where it was disturbed and it is possible determine and continue processing a plurality of sessions.

In an embodiment of the message arrangement 150, the message header may comprise a section for sequence identification. A tool communications network 50 may be operated in a challenging network environment with disturbances, wireless connected devices operated on battery and some areas might be out of network reach. Therefore it may be desired to be able to handle situations where the communication between two parties is either temporarily broken, or when the communication is disturbed such that messages may be received in a different order than transmitted.

In an embodiment of the message arrangement 150, when the message header may contain an operation instruction for the tool controller 100, the message structure 150 may only contain a message header. In a normal operation, the tool controller 100 receives control data and provides control data for control of a power tool 130. However, from time to time, it may be necessary to provide configuration data or instructions for the tool controller 100 itself. A few non-limiting examples of such instructions for the tool controller 100 may be reboot of the tool controller, shut down, or keep-alive-messages. Messages with such instructions for the tool controller 100 itself, may not need to carry a message body.

In an embodiment, the message header may comprise a primary header and a secondary header. The header may be serialized. Thereby it may enable flexibility for future changes of the secondary header with limited impact on systems using an older version of the header. Depending on interest, entities receiving a message do not need to interpret all data, but only data of interest to a particular entity need to be deserialized, such as tool controller 100, tool server 110 or communication node 120.

In an embodiment, a part of the message header, for example the primary header may comprise at least one of:
a checksum for primary header for protection of size field,
size of complete message,
protocol version,
size of secondary header,
message classification of “event”, “result, “Keep Alive”, “read”, “update”, “invoke”,
destination issuing entity including system identification and a unique identifier for a particular system type,
source issuing entity including a number indicating system type and a system type identification.

In an embodiment, a part of the message header, for example the secondary header may comprise at least one of:
session identity created by issuing entity for identifying session being addressed or created by serving entity when session is established/allocated,
unique id of current message for matching of request to reply,
flags added by both issuing entity and serving,
function for identification of function to invoke, e.g. Read, Update, SelectWorktask etc,
result code for serving or routing entity to set a code to indicate how message completed, e.g. OK, Timeout, RoutingError, InvalidSession, InvalidData etc, encoding for indication of data encoding, e.g. plain or zip,
timestamp when message was sent,
sequence size for when a message data may be split into several messages this indicates how many messages,
sequence count for when a message data is split into several messages this may specify what part of the complete data the current message contains.

The secondary header may contain information to be used by routing entity to find correct communication channel. It also may contain message specific information like sequence number, function and result code.

In an embodiment, the message header may comprise at least one of source port, destination port, sequence number, acknowledgment number, offset, checksum, length, version, header length, type of service message length, identification, time to live, protocol header checksum, source address, destination address, option.

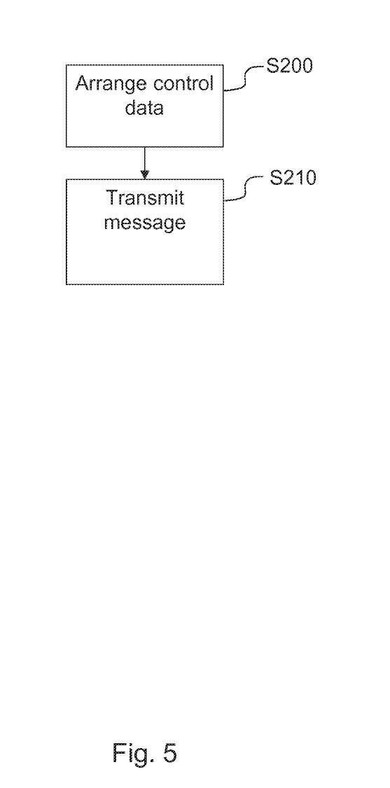

FIG. 5 illustrates an embodiment of a flowchart, performed by a transmitter node 170 in a tool communications network 50 for enabling of remote control of power tools 130. The tool communications network 50 comprises a tool server 110 and a tool controller 100. At least one power tool 130 is connected to the tool controller 100. The method comprises arrangement of control data in a message structure 150, in a step S200. The method comprises transmission of a message based on the message structure 150 to a receiver node 180, in a step S210.

In an embodiment, the transmitter node 170 transmitting the message structure 150, may comprise a message header for message transmission and a message body for carrying control data. The message arrangement may comprise that the message body comprise at least one data container. The data container may contain at least one individual control data item. The message arrangement may comprise that the control data item contains both metadata and value data. The message arrangement may comprise that the control data item is expressed in a binary format.

In an embodiment of the method performed by the transmitter node 170, a computer program may be received. The computer program may be received from a compiler 160. The computer program may be used for interpretation of the message structure 150. At updates or changes of the message structure 150, it may enhance or simplify the adaptation process of the transmitter node 170 for message interpretation, to receive a compiled program for interpretation of the message structure 150.

In an embodiment of the method performed by the transmitter node 170, the transmitter node 170 may be comprised by one from the group of: a tool server 110, a communication node 120 or a tool controller 100. The transmitter node 170 may be a dedicated transmitter node in a tool communications network 50 for transmission of message structures 150. The transmitter node 170 may be a transmitter node integrated in or co-located with a tool server 110, a communication node 120, power tool 130, or a tool controller 100. The transmitter node 170 may be a transmitter node integrated in or co-located with other suitable nodes in a tool communications network 50.

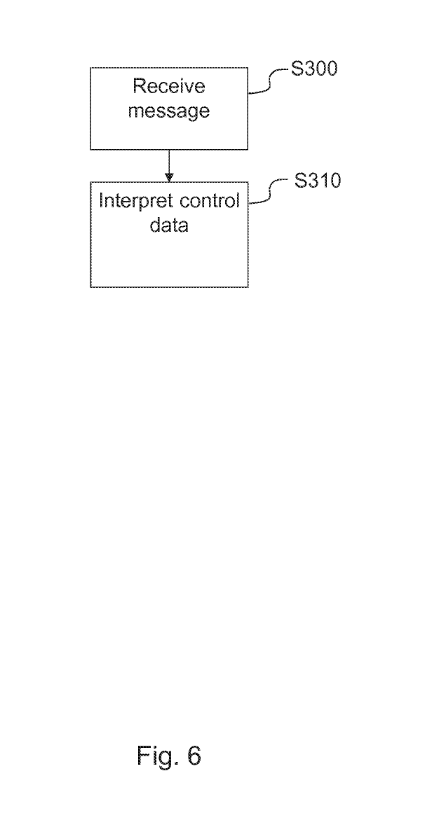

FIG. 6 illustrates an embodiment of a flowchart of a method performed by a receiver node 180 in a tool communications network 50 for enabling of remote control of power tools 130. The tool communications network 50 comprises a tool server 110 and a tool controller 100. At least one power tool 130 is connected to the tool controller 100. The method comprises receiving a message based on a message structure 150 from a transmitter node 170, in a step S300. The method comprises interpreting control data in a message structure 150, in a step S310.

In an embodiment, the receiver node 180 receiving the message structure 150, may comprise a message header for message transmission and a message body for carrying control data. The message arrangement may comprise that the message body comprise at least one data container. The data container may contain at least one individual control data item. The message arrangement may comprise that the control data item contains both metadata and value data. The message arrangement may comprise that the control data item is expressed in a binary format.

In an embodiment of the method performed by the receiver node 180, a computer program may be received a from a compiler 160 for interpretation of the message structure 150. At updates or changes of the message structure 150, it may enhance or simplify the adaptation process of the receiver node 180 for message interpretation, to receive a compiled program for interpretation of the message structure 150.

In an embodiment of the method performed by the receiver node 180, the receiver node 180 may be comprised by one from the group of: a tool server 110, a communication node 120 or a tool controller 100. The receiver node 180 may be a dedicated receiver node in a tool communications network 50 for reception of message structures 150. The receiver node 180 may be a receiver node integrated in or co-located with a tool server 110, a communication node 120, power tool 130, or a tool controller 100. The receiver node 180 may be a receiver node integrated in or co-located with other suitable nodes in a tool communications network 50.

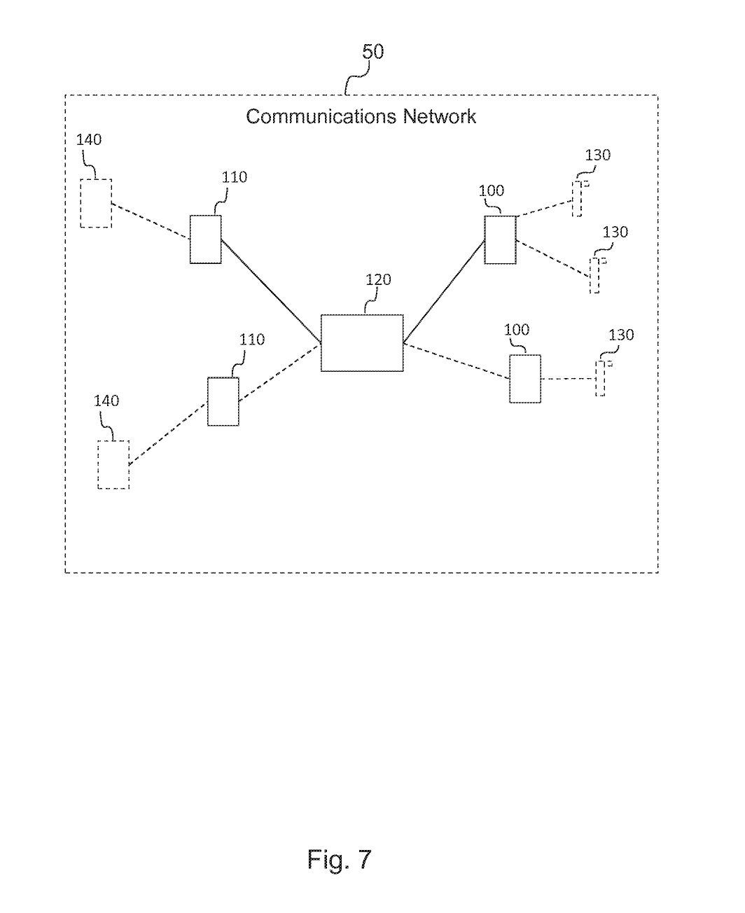

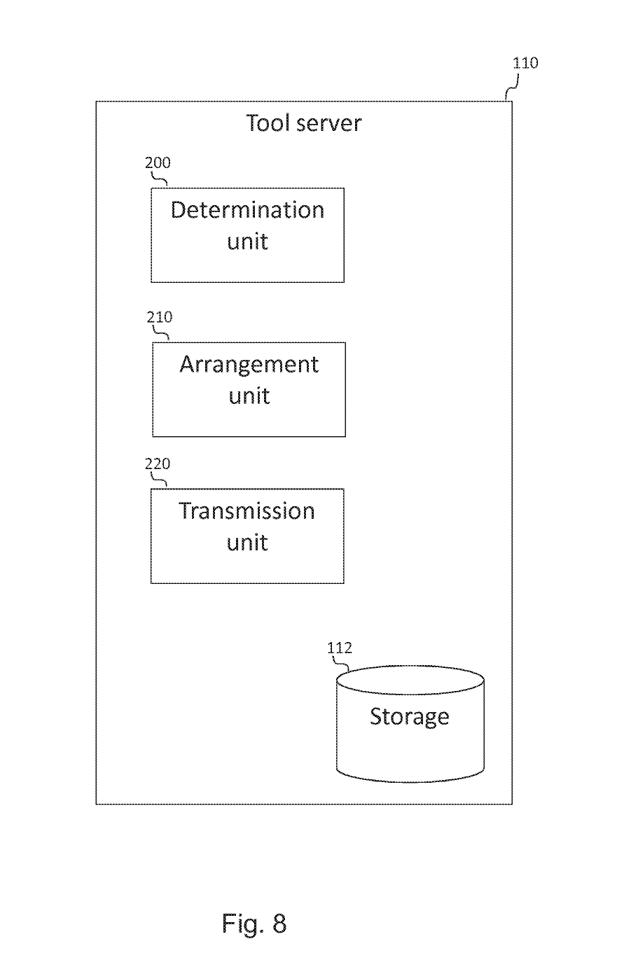

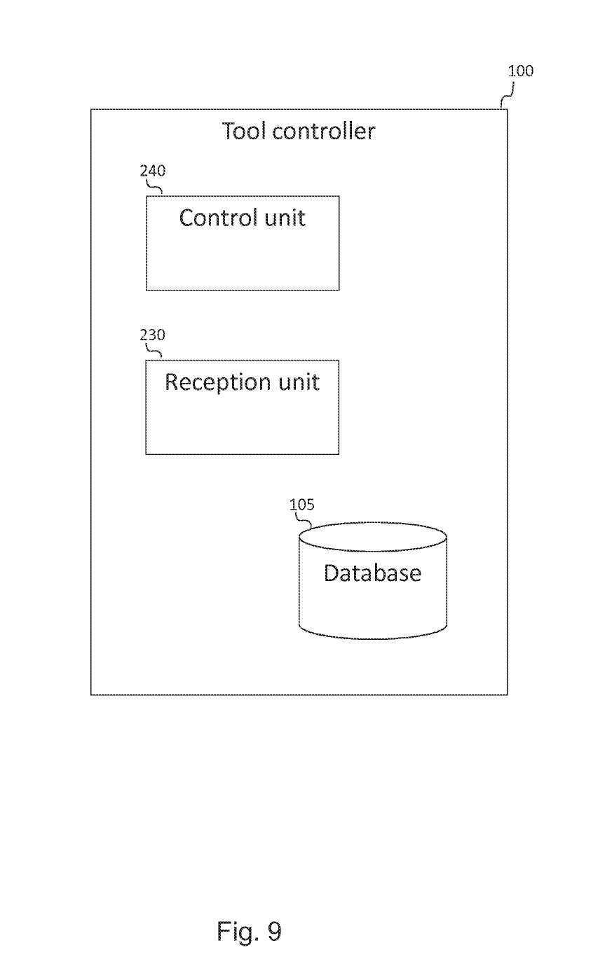

FIG. 7 through FIG. 9 illustrates an embodiment of a tool communications network 50, for enabling of remote control of power tools 130. The tool communications network 50 comprises a tool server 110, a communication node 120 and a tool controller 100. At least one power tool 130 is connected to the tool controller 100. The tool communications network 50 comprises a determination unit 200 for determination of control data, comprised by the tool server 110. The tool communications network 50 comprises an arrangement unit 210 for arrangement of the control data in a message structure 150, comprised by the tool server 110. The message structure 150 comprises a message header for message transmission and a message body for carrying control data, the message body comprising at least one data container, wherein the data container contains at least one individual control data item, the control data item contains both metadata and value data, and the control data item is expressed in a binary format. The tool communications network 50 comprises a transmission unit 220 for transmission of a message based on the message structure 150 comprising the control data, comprised by the tool server 110. The tool communications network 50 comprises a reception unit 230 for reception of the message based on the message structure 150 comprising the control data, comprised by the tool controller 100. The tool communications network 50 comprises a control unit 240 for storage of the control data according to the message structure 150 in a database 105, comprised by the tool controller 100.

In an embodiment, the message authenticity and/or authorization for relay to a tool controller 100, may be validated by the communication node 120.

In an embodiment, the message structure 150 may be used by a compiler 160 for generation of a computer program for a transmitter node 170, and/or generation of a computer program for a receiver node 180.

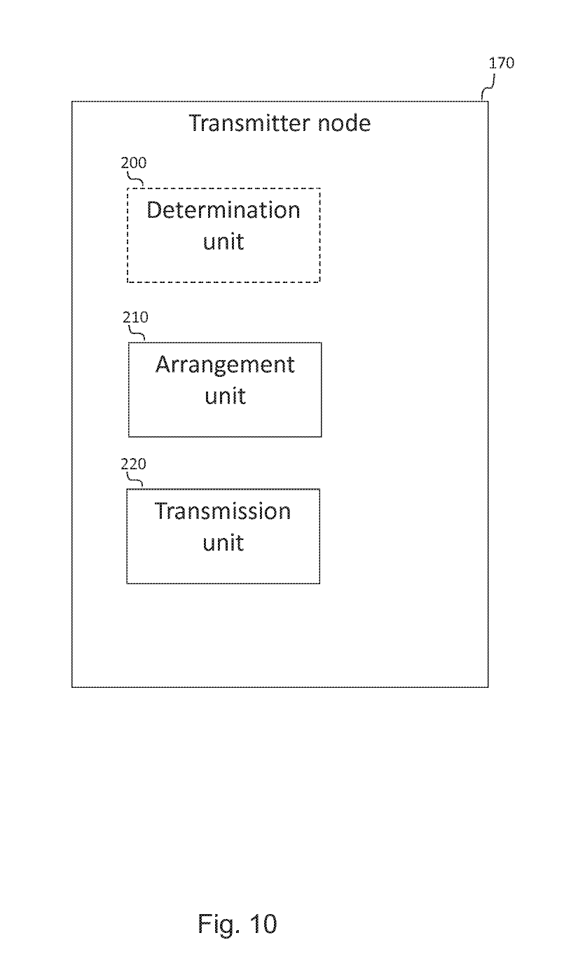

FIG. 10 illustrates a transmitter node 170 in a tool communications network 50, for enabling of remote control of power tools 130. The tool communications network 50 comprises a tool server 110 and a tool controller 100. At least one power tool 130 is connected to the tool controller 100. The transmitter node 170 comprises an arrangement unit 210 for arrangement of control data in a message structure 150. The transmitter node 170 comprises a transmission unit 220 for transmission of a message based on the message structure 150 to a receiver node 180.

In an embodiment, the transmitter node 170 may be arranged to receive a computer program from a compiler 160 for interpretation of the message structure 150.

In an embodiment, the transmitter node 170 may be comprised by one from the group of: a tool server 110, a communication node 120 or a tool controller 100.

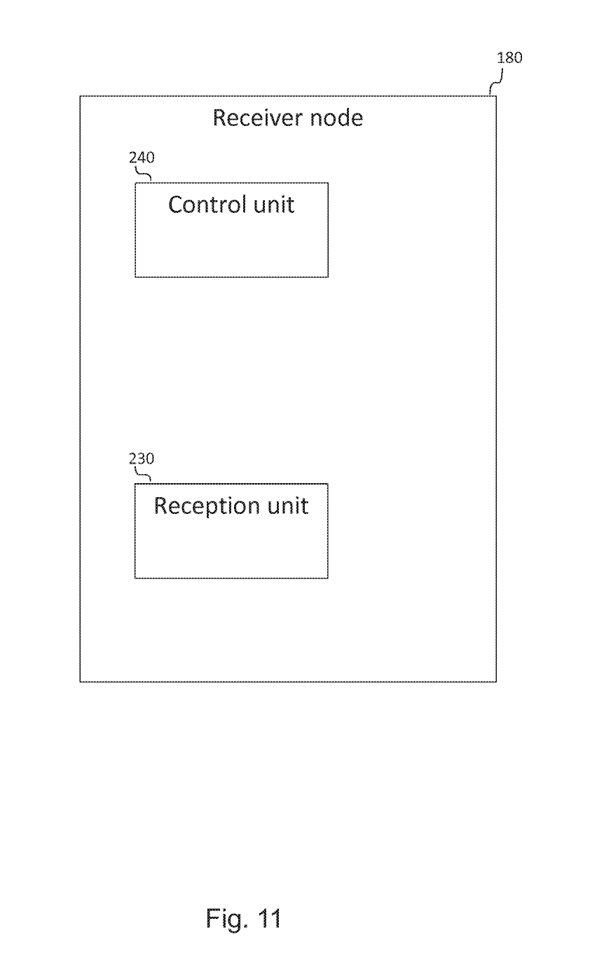

FIG. 11 illustrates a receiver node 180 in a tool communications network 50, for enabling of remote control of power tools 130. The tool communications network 50 comprises a tool server 110 and a tool controller 100. At least one power tool 130 is connected to the tool controller 100. The receiver node 180 comprises a reception unit 230 for reception of a message based on a message structure 150 from a transmitter node 170. The receiver node 180 comprises a control unit 240 for interpretation of control data in the message structure 150.

In an embodiment, the receiver node 180 may be arranged to receive a computer program from a compiler 160 for interpretation of the message structure 150.

In an embodiment, the receiver node 180 may be comprised by one from the group of: tool server 110, communication node 120 or tool controller 100.

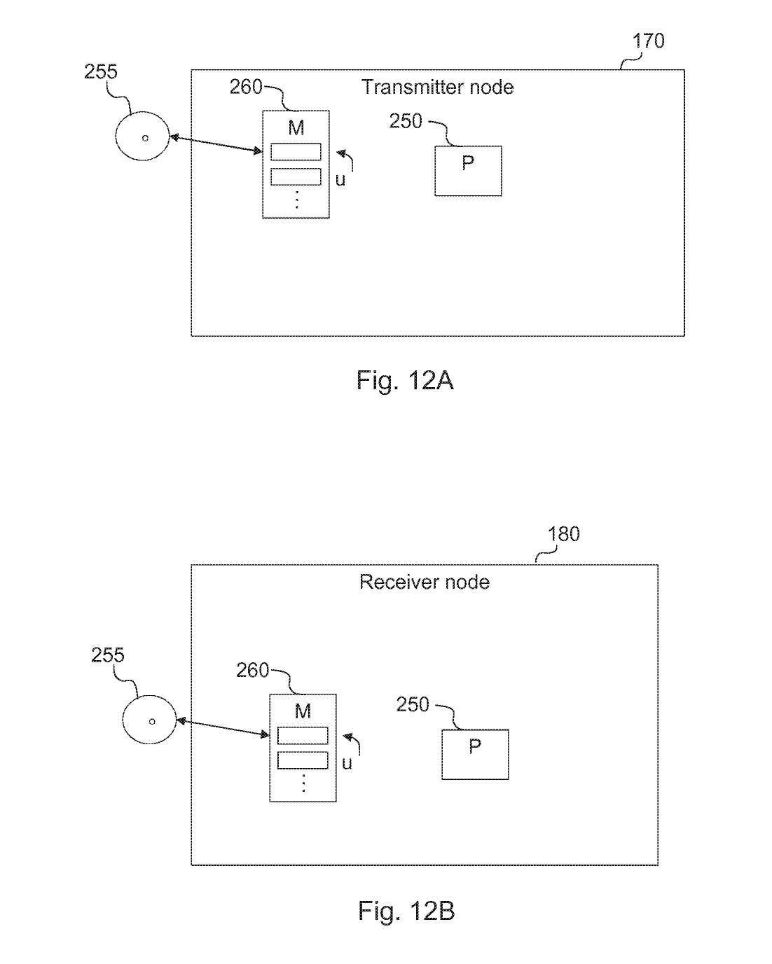

Looking at FIG. 12A and FIG. 12B, the described transmitter node 170 and the receiver node 180 described above may be implemented, by means of program units of a respective computer program comprising code means which, when run by processors “P” 250 causes the described transmitter node 170 and the receiver node 180 to perform the above-described actions. The processors P 250 may comprise a single Central Processing Unit (CPU), or could comprise two or more processing units. For example, the processors P 250 may include general purpose microprocessors, instruction set processors and/or related chips sets and/or special purpose microprocessors such as Application Specific Integrated Circuits (ASICs), Field Programmable Gate Arrays (FPGAs) or Complex Programmable Logic Devices (CPLDs). The processors P 250 may also comprise a storage for caching purposes.

Each computer program may be carried by computer program products “M” 260 in the described transmitter node 170 and the receiver node 180, in the form of memories having a computer readable medium and being connected to the processor P. The computer program products may be carried by a medium 255, such as CD, DVD, flash memory, or downloadable objects. Each computer program product M 260 or memory thus comprises a computer readable medium on which the computer program is stored e.g. in the form of computer program units “u”. For example, the memories M 260 may be a flash memory, a Random-Access Memory (RAM), a Read-Only Memory (ROM) or an Electrically Erasable Programmable ROM (EEPROM), and the program unit's u could in alternative embodiments be distributed on different computer program products in the form of memories within the described transmitter node 170 and the receiver node 180.

While the solution has been described with reference to specific exemplary embodiments, the description is generally only intended to illustrate the inventive concept and should not be taken as limiting the scope of the solution. For example, the terms “tool communications network”, “message arrangement”, “tool server” and “tool controller” have been used throughout this description, although any other corresponding nodes, functions, and/or parameters could also be used having the features and characteristics described here. The solution is defined by the appended claims.

1-29. (canceled)

30. A method performed by a tool communications network for enabling remote control of power tools, the tool communications network comprising a tool server, a communication node and a plurality of tool controllers, and wherein at least one power tool is connected to at least one tool controller, the method comprising:
determining control data by the tool server;
arranging the control data in a message structure by the tool server, the message structure comprising a message header for message transmission and a message body for carrying control data, the message body comprising at least one data container, wherein the data container contains at least one individual control data item, the control data item contains both metadata and value data, and the control data item is expressed in a binary format;
transmitting a message based on the message structure comprising the control data, by the tool server;
receiving the message based on the message structure comprising the control data, by the at least one tool controller; and
storing the control data according to the message structure in a database of the at least one tool controller.

31. The method according to claim 30, wherein at least one of the message authenticity and authorization for relay to the at least one tool controller is validated by the communication node.

32. The method according to claim 30, wherein the message structure is used by a compiler for generation of:
a computer program for a transmitter node; and
a computer program for a receiver node.

33. A message arrangement for use in a tool communications network for enabling of remote control of power tools, the tool communications network comprising a tool server and a plurality of tool controllers, and wherein at least one power tool is connected to at least one tool controller, the message arrangement comprising a message structure comprising a message header for message transmission and a message body for carrying control data, the message body comprising at least one data container, wherein the data container contains at least one individual control data item, the control data item contains both metadata and value data, and the control data item is expressed in a binary format.

34. The message arrangement according to claim 33, wherein the message body comprises a plurality of data containers, wherein a data container contains at least one sub data container.

35. The message arrangement according to claim 33, wherein the metadata determines at least one of: value type, parameter, type, name length, value length, attributes length, sub data container length, name, and attributes.

36. The message arrangement according to claim 33, wherein the value data determines a magnitude of a power tool operation.

37. The message arrangement according to claim 33, wherein the message is arranged such that when a message body contains a plurality of data containers, an individual data container or individual control data item can interpret the message structure.

38. The message arrangement according to claim 33, wherein the message header comprises a section for session identification.

39. The message arrangement according to claim 33, wherein the message header comprises a section for sequence identification.

40. The message arrangement according to claim 33, wherein, when the message header contains an operation instruction for the at least one tool controller, the message structure only contains a message header.

41. A method performed by a transmitter node in a tool communications network for enabling of remote control of power tools, the tool communications network comprising a tool server and at least one tool controller, and wherein at least one power tool is connected to the at least one tool controller, the method comprising:
arranging control data in a message structure according to claim 32; and
transmitting a message based on the message structure to the receiver node.

42. The method according to claim 41, further comprising receiving a computer program from the compiler for interpretation of the message structure.

43. The method according to claim 41, wherein the transmitter node is comprised by one from the group of: a tool server, a communication node and a tool controller.

44. A method performed by a receiver node in a tool communications network for enabling of remote control of power tools, the tool communications network comprising a tool server and a plurality of tool controllers, and wherein at least one power tool is connected to at least one tool controller, the method comprising:
receiving a message based on a message structure from a transmitter node; and
interpreting control data in a message structure according to claim 32.

45. The method according to claim 44, further comprising receiving a computer program from the compiler for interpretation of the message structure.

46. The method according to claim 44, wherein the receiver node is comprised by one from the group of: a tool server, a communication node and a tool controller.

47. A tool communications network for enabling of remote control of power tools, the tool communications network comprising a tool server, a communication node and a plurality of tool controllers, and wherein at least one power tool is connected to at least one tool controller, the tool communications network comprises:
a determination unit for determination of control data, comprised by the tool server;
an arrangement unit for arrangement of the control data in a message structure, comprised by the tool server, the message structure comprising a message header for message transmission and a message body for carrying control data, the message body comprising at least one data container, wherein the data container contains at least one individual control data item, the control data item contains both metadata and value data, and the control data item is expressed in a binary format;
a transmission unit for transmission of a message based on the message structure comprising the control data, comprised by the tool server;
a reception unit for reception of the message based on the message structure comprising the control data, comprised by the tool controller; and
a control unit for storage of the control data according to the message structure in a database, comprised by the tool controller.

48. The tool communications network according to claim 47, wherein at least one of the message authenticity and authorization for relay to a tool controller is validated by the communication node.

49. The tool communications network according to claim 47, wherein the message structure is used by a compiler for generation of:
a computer program for a transmitter node; and
a computer program for a receiver node.

50. A transmitter node in a tool communications network for enabling of remote control of power tools, the tool communications network comprising a tool server and a plurality of tool controllers, and wherein at least one power tool is connected to at least one tool controller, the transmitter node comprising:
an arrangement unit for arrangement of control data in a message structure according to claim 32; and
a transmission unit for transmission of a message based on the message structure to a receiver node.

51. The transmitter node according to claim 50, wherein the transmitter node is arranged to receive a computer program from the compiler for interpretation of the message structure.

52. The transmitter node according to claim 50, wherein the transmitter node is comprised by one from the group of: a tool server, a communication node and a tool controller.

53. A receiver node in a tool communications network for enabling of remote control of power tools, the tool communications network comprising a tool server and a plurality of tool controllers, and wherein at least one power tool is connected to at least one tool controller, the receiver node comprising:
a reception unit for reception of a message based on a message structure from a transmitter node; and
a control unit for interpretation of control data in the message structure according to claim 32.

54. The receiver node according to claim 53, wherein the receiver node is arranged to receive a computer program from the compiler for interpretation of the message structure.

55. The receiver node according to claim 53, wherein the receiver node is comprised by one from the group of: a tool server, a communication node and a tool controller.

56. A computer program comprising computer readable code which, when run on a transmitter node, causes the transmitter node to behave as a transmitter node according to claim 50.

57. A computer program product comprising a computer program comprising computer readable code which, when run on a transmitter node, causes the transmitter node to behave as a transmitter node according to claim 50.

58. A computer program comprising computer readable code which, when run on a receiver node, causes the receiver node to behave as a receiver node according to claim 53.

59. A computer program product comprising a computer program comprising computer readable code which, when run on a receiver node, causes the receiver node to behave as a receiver node according to claim 53.
